(19) United States
(12) Patent Application Publication
(10) Pub. No.: US 2025/0145813 A1
(43) Pub. Date: May 8, 2025

(54) THERMOPLASTIC ELASTOMER COMPOSITION AND APPLICATION THEREOF

(71) Applicant: MITSUI CHEMICALS, INC., Chuo-ku,Tokyo (JP)

(72) Inventors: Suguru TANAKA, Funabashi-shi, Chiba (JP); Yusuke YODA, Kawasaki-shi, Kanagawa (JP)

(73) Assignee: MITSUI CHEMICALS, INC., Chuo-ku,Tokyo (JP)

(21) Appl. No.: 18/719,702

(22) PCT Filed: Dec. 22, 2022
(86) PCT No.: PCT/JP2022/047293

§ 371 Date: Dec. 18, 2024

(30) Foreign Application Priority Data
Dec. 24, 2021 (JP) 2021-210976

(51) Int. Cl. C08L 23/16

(52) U.S. Cl. CPC C08L 23/16; C08L 2205/02; C08L 2205/03; C08L 2207/04

(57) ABSTRACT

An object of the present disclosure is to provide a thermoplastic elastomer composition with good oil permeability resistance (oil impermeability). The present disclosure pertains to a thermoplastic elastomer composition containing an ethylene copolymer (A) having a weight-average molecular weight of 350,000 or more, a crystalline olefin polymer (B), a crosslinking agent (C), and a plasticizer (D), wherein the content of the plasticizer (D) is less than 130 parts by mass based on 100 parts by mass of the copolymer (A).

### TECHNICAL FIELD

The present disclosure relates to a thermoplastic elastomer composition with good oil permeability resistance (oil impermeability).

### BACKGROUND ART

An olefin thermoplastic elastomer obtained by crosslinking a composition containing an ethylene/α-olefin/non-conjugated polyene copolymer, a kind of thermoplastic elastomers, and a crystalline olefin polymer are lightweight and easy to recycle, and is thus widely used as a thermoplastic elastomer of an energy saving and resources saving type, particularly as a substitute for a vulcanized rubber, for automobile parts such as hoses, pipes, and boots (blow molded articles) for automobiles, and the like (e.g., Patent Documents 1 and 2).

### CITATION LIST

### Patent Documents

[Patent Document 1] JP2001-294714A

[Patent Document 2] JP2011-202136A

### SUMMARY OF INVENTION

### Technical Problem

Although these automobile parts are used at positions in contact with an engine oil, lubricating oil, grease, and the like, olefin thermoplastic elastomers generally have a low oil resistance. As such, the automobile parts obtained including the olefin thermoplastic elastomers described in

Patent Documents 1 and 2 also require further improvement in oil permeability resistance.

An object of the present disclosure is to provide a thermoplastic elastomer composition with good oil permeability resistance (oil impermeability).

### Solution to Problem

The present disclosure pertains to a thermoplastic elastomer composition comprising:
an ethylene copolymer (A) having a weight-average molecular weight of 350,000 or more;
a crystalline olefin polymer (B);
a crosslinking agent (C); and
a plasticizer (D);
wherein a content of the plasticizer (D) is less than 130 parts by mass based on 100 parts by mass of the copolymer (A).

### Advantageous Effects of Invention

According to the present disclosure, it is possible to provide a thermoplastic elastomer composition with good oil permeability resistance (oil impermeability).

Since a molded body composed of the thermoplastic elastomer composition of the present disclosure has good oil permeability resistance (oil impermeability), the molded body can be suitably used not only in an applications where a conventional thermoplastic elastomer composition is used, but also in an application where it is difficult to use a molded body composed of a conventional thermoplastic elastomer composition, for example, an automobile part such as an air intake hose.

### DESCRIPTION OF EMBODIMENTS

Hereinafter, embodiments of the present disclosure will be described. Unless otherwise specified, the expression “XX or more and YY or less” or “XX to YY”, which represents a numerical range, means a numerical range that includes the lower and upper limits that are the end points. When numerical ranges are indicated incrementally, the upper and lower limits of each numerical range can be arbitrarily combined.

### Ethylene Copolymer (A)

The ethylene copolymer (A), one of the components of the thermoplastic elastomer composition of the present disclosure (hereinafter sometimes referred to as “component (A)”), is a copolymer including a unit derived from ethylene and has a weight-average molecular weight (Mw) of 350,000 or more, preferably 420,000 or more, and more preferably in the range of 450,000 to 800,000. The ethylene copolymer (A) may be an ethylene/α-olefin copolymer including a unit derived from ethylene and a unit derived from an α-olefin (e.g., an α-olefin having 3 to 20 carbon atoms).

The upper limit of Mw is not particularly limited, but is usually 1,500,000 or less, and preferably 1,000,000 or less.

An ethylene polymer having an Mw of less than 350,000 may not improve the oil permeability resistance of a molded body obtained from the thermoplastic elastomer composition.

The Mw of the ethylene copolymer (A) according to the present disclosure is measured by gel permeation chromatography. The measurement method will be mentioned below.

The ethylene copolymer (A) according to the present disclosure can be obtained, for example, by copolymerizing at least ethylene and α-olefin. Examples of the α-olefin include propylene, 1-butene, 1-pentene, 1-hexene, 4-methyl-1-pentene, 1-heptene, 1-octene, 1-nonene, 1-decene, 1-undecene, and 1-dodecene. Among these, from the viewpoint of imparting flexibility, an α-olefin having 3 to 20 carbon atoms is preferable; an α-olefin having 3 to 12 carbon atoms is more preferable; propylene, 1-butene, and 1-octene are even more preferable; and propylene is further preferable.

When the component (A) according to the present disclosure is an ethylene/α-olefin copolymer including a unit derived from ethylene and a unit derived from an α-olefin, a molar ratio of the unit derived from ethylene to the unit derived from an α-olefin is usually in the range of 40/60 to 90/10. The lower limit of the molar ratio of the unit derived from ethylene to the unit derived from an α-olefin is preferably 45/55, more preferably 50/50, and particularly preferably 55/45. The upper limit of the molar ratio is preferably 80/20, more preferably 75/25, and even more preferably 70/30.

The molar ratio is preferably in the above range in order to obtain a thermoplastic elastomer composition having excellent mechanical strength.

If necessary, a monomer (non-conjugated polyene) having an unsaturated bond can be copolymerized when the component (A) according to the present disclosure is produced. Examples of the monomer having an unsaturated bond (non-conjugated polyene) include chain non-conjugated dienes such as 1,4-hexadiene, 1, 6-octadiene, 2-methyl-1,5-hexadiene, 6-methyl-1,5-heptadiene, and 7-methyl-1,6-octadiene; cyclic non-conjugated dienes such as cyclohexadiene, dicyclopentadiene, methyltetrahydroindene, 5-vinyl-2-norbornene, 5-ethylidene-2-norbornene, 5-methylene-2-norbornene, 5-isopropylidene-2-norbornene, and 6-chloromethyl-5-isopropenyl-2-norbornene; and trienes such as 2,3-diisopropylidene-5-norbornene, 2-ethylidene-3-isopropylidene-5-norbornene, 2-propenyl-2,5-norbornadiene, 1,3,7-octatriene, 1,4,9-decatriene, 4,8-dimethyl-1,4,8-decatriene, and 4-ethylidene-8-methyl-1,7-nonadiene. Among them, the monomers are preferably chain non-conjugated dienes such as 1,4-hexadiene and cyclic non-conjugated dienes such as 5-ethylidene-2-norbornene and 5-vinyl-2-norbornene, more preferably cyclic non-conjugated dienes, and even more preferably 5-ethylidene-2-norbornene and 5-vinyl-2-norbornene.

The monomer having an unsaturated bond (non-conjugated polyene) may be used alone or in combination of two or more thereof.

Examples of the copolymers (A) according to the present disclosure include ethylene/α-olefin/non-conjugated polyene copolymers such as ethylene/propylene/1,4-hexadiene copolymer, ethylene/propylene/5-ethylidene-2-norbornene copolymer, ethylene/propylene/5-ethylidene-2-norbornene/5-vinyl-2-norbornene copolymer, ethylene/1-butene/1,4-hexadiene copolymer, ethylene/1-pentene/1,4-hexadiene copolymer, ethylene/1-hexene/1,4-hexadiene copolymer, ethylene/1-heptene/1,4-hexadiene copolymer, ethylene/1-octene/1,4-hexadiene copolymer, ethylene/1-nonene/1,4-hexadiene copolymer, ethylene/1-decene/1,4-hexadiene copolymer, ethylene/1-butene/1-octene/1,4-hexadiene copolymer, ethylene/1-butene/5-ethylidene-2-norbornene copolymer, ethylene/1-pentene/5-ethylidene-2-norbornene copolymer, ethylene/1-hexene/5-ethylidene-2-norbornene copolymer, ethylene/1-heptene/5-ethylidene-2-norbornene copolymer, ethylene/1-octene/5-ethylidene-2-norbornene copolymer, ethylene/1-nonene/5-ethylidene-2-norbornene copolymer, ethylene/1-decene/5-ethylidene-2-norbornene copolymer, ethylene/1-butene/1-octene/5-ethylidene-2-norbornene copolymer, ethylene/1-butene/5-ethylidene-2-norbornene/5-vinyl-2-norbornene copolymer, ethylene/1-pentene/5-ethylidene-2-norbornene/5-vinyl-2-norbornene copolymer, ethylene/1-hexene/5-ethylidene-2-norbornene/5-vinyl-2-norbornene copolymer, ethylene/1-heptene/5-ethylidene-2-norbornene/5-vinyl-2-norbornene copolymer, ethylene/1-octene/5-ethylidene-2-norbornene/5-vinyl-2-norbornene copolymer, ethylene/1-nonene/5-ethylidene-2-norbornene/5-vinyl-2-norbornene copolymer, ethylene/1-decene/5-ethylidene-2-norbornene/5-vinyl-2-norbornene copolymer, and ethylene/1-butene/1-octene/5-ethylidene-2-norbornene/5-vinyl-2-norbornene copolymer.

As ethylene/α-olefin/non-conjugated polyene copolymer, one of the ethylene copolymers (A) according to the present disclosure, for example, ethylene/propylene/non-conjugated diene copolymers are manufactured and sold, such as trade name Vistalon 3666 (ethylene/propylene/5-ethylidene-2-norbornene copolymer) by ExxonMobil Chemical Company, trade names Royalene 694 and Royalene 677 (ethylene/propylene/5-ethylidene-2-norbornene copolymers) by Lion Copolymer, and trade names Keltan 4869C, Keltan 5469C, Keltan 5469Q, and Keltan 4969Q (ethylene/propylene/5-ethylidene-2-norbornene copolymers) by LANXESS Corporation.

### Crystalline Olefin Polymer (B)

The crystalline olefin polymer (B), one of the components of the thermoplastic elastomer composition of the present disclosure, is a polymer of an α-olefin, usually an olefin polymer obtained by polymerizing one or more α-olefins, and is a crystalline polymer containing an olefin, examples of which include ethylene polymers such as an ethylene homopolymer manufactured and sold under the name of high-pressure low-density polyethylene, linear low-density polyethylene, and medium-density polyethylene or high-density polyethylene, and a polymer of ethylene and another α-olefin; propylene polymers, such as a homopolymer of propylene manufactured and sold under the names of propylene homopolymer (homo PP), propylene random copolymer (random PP), propylene block copolymer and (block PP), and a copolymer of propylene and another α-olefin; 1-butene polymers, such as a homopolymer of 1-butene and a copolymer of 1-butene and another α-olefin; and 4-methyl-1-pentene polymers, such as a homopolymer of 4-methyl-1-pentene and a copolymer of 4-methyl-1-pentene and another α-olefin.

In the present disclosure, a crystalline polymer is a polymer having a crystal-based melting point at 120° C. or higher.

These α-olefins preferably include α-olefins having 2 to 20 carbon atoms, and specific examples thereof include ethylene, propylene, 1-butene, 1-pentene, 1-hexene, 1-octene, 1-decene, 2-methyl-1-propene, 3-methyl-1-pentene, 4-methyl-1-pentene, and 5-methyl-1-hexene. The α-olefins may be used alone or in combination of two or more.

The crystalline olefin polymer (B) that can be used is a propylene polymer such as polypropylene but is not limited thereto, and a known crystalline olefin polymer can be used.

### Propylene Polymer

The propylene polymer according to the present disclosure particularly preferably includes one or more polymers selected from a homopolymer of propylene, a random copolymer of propylene and an α-olefin other than propylene (e.g., a propylene/ethylene random copolymer or a propylene/ethylene/1-butene random copolymer), and a block copolymer of propylene and an α-olefin other than propylene (e.g., a propylene/ethylene block copolymer).

The crystalline olefin polymer (B) according to the present disclosure preferably has an MFR (JIS K7210, temperature: 230° C., 2.16 kg load) of 0.01 to 3.0 g/10 min, and more preferably 0.1 to 1.0 g/10 min.

### Crosslinking Agent (C)

The crosslinking agent (C), one of the components of the thermoplastic elastomer composition of the present disclosure, is not particularly limited as long as it is a compound capable of crosslinking the ethylene copolymer (A) and the crystalline olefin polymer (B), and specific examples thereof include an organic peroxide crosslinking agent and a phenol resin crosslinking agent.

### Organic Peroxide-Based Crosslinking Agent

Specific examples of the organic peroxide to be used as a crosslinking agent include dicumyl peroxide, di-tert-butylperoxide, 2,5-dimethyl-2,5-di-(tert-butylperoxy)hexane, 2,5-dimethyl-2,5-di-(tert-butylperoxy)hexyne-3, 1,3-bis(tert-butylperoxyisopropyl)benzene, 1,1-bis(tert-butylperoxy)-3,3,5-trimethylcyclohexane, n-butyl-4,4-bis(tert-butylperoxy)valerate, benzoyl peroxide, p-chlorobenzoyl peroxide, 2,4-dichlorobenzoyl peroxide, tert-butylperoxybenzoate, tert-butylperoxyisopropylcarbonate, diacetyl peroxide, lauroyl peroxide, and tert-butyl cumyl peroxide.

Among these, from the viewpoint of odor properties, and scorch stability, 2,5-dimethyl-2,5-di-(tert-butylperoxy)hexane, 2,5-dimethyl-2,5-di-(tert-butylperoxy)hexyne-3, 1,3-bis(tert-butylperoxyisopropyl)benzene, 1,1-bis(tert-butylperoxy)-3,3,5-trimethylcyclohexane, and n-butyl-4,4-bis(tert-butylperoxy)valerate are preferable, and above all, 2,5-dimethyl-2,5-di-(tert-butylperoxy)hexane and 1,3-bis(tert-butylperoxyisopropyl)benzene are most preferable.

In the present disclosure, the organic peroxide is usually used at a ratio of 0.05 to 3 parts by mass, preferably 0.1 to 1 part by mass, based on 100 parts by mass of the total amount of the ethylene copolymer (A) and the crystalline olefin polymer (B).

On the occasion of crosslinking treatment with organic peroxides, crosslinking auxiliary agents such as sulfur, p-quinone dioxime, p,p′-dibenzoylquinone dioxime, N-methyl-N-4-dinitrosoaniline, nitrosobenzene, diphenylguanidine, trimethylolpropane, N,N′-m-phenylenedimaleimide, divinylbenzene, and triallylcyanurate, or polyfunctional methacrylate monomers such as ethylene glycol dimethacrylate, diethylene glycol dimethacrylate, polyethylene glycol dimethacrylate, trimethylolpropane trimethacrylate, and allyl methacrylate; polyfunctional vinyl monomers such as vinyl butyrate and vinyl stearate can be blended.

By using such compounds, a uniform and mild crosslinking reaction can be expected.

It is preferable to use such compounds in the thermoplastic elastomer composition at a ratio of 0.1 to 2% by mass, especially 0.3 to 1% by mass, in order to achieve good flowability of the resulting thermoplastic elastomer and to prevent changes in physical properties due to thermal history during processing and molding.

### Phenol Resin-Based Crosslinking Agent

A phenol resin used as a crosslinking agent is also referred to as a phenolic curative, and refers to vulcanizing agent containing a phenolic curing resin, preferably a phenolic curative system composed of a phenolic curing resin and a curing activator as disclosed in U.S. Pat. No. 4,311,628.

The basic components of the system are phenolic curable resins produced by condensation of substituted phenols (e.g., halogen-substituted phenols, C₁-C₂ alkyl-substituted phenols) or non-substituted phenols with aldehydes, preferably formaldehyde, in an alkaline medium, or by condensation of bifunctional phenol dialcohols (preferably dimethylol phenols substituted with a C₅-C₁₀ alkyl group at the para position). Halogenated alkyl-substituted phenolic curable resins produced by halogenation of alkyl-substituted phenolic curable resins are particularly suitable. Phenolic curative systems composed of methylolphenol curing resin, halogen donors, and metal compounds are particularly recommended and are all described in detail in U.S. Pat. Nos. 3,287,440 and 3,709,840. Non-halogenated phenolic curing resins are used simultaneously with halogen donors, preferably with hydrogen halide scavengers. Usually, halogenated phenolic curable resins, preferably brominated phenolic curable resins containing 2 to 10% by weight of bromine, do not require halogen donors, but are used simultaneously with hydrogen halide scavengers such as iron oxide, titanium oxide, magnesium oxide, magnesium silicate, silicon dioxide and preferably metal oxides such as zinc oxide. The presence of such scavengers promotes the crosslinking action of phenolic curable resins, but in the case of rubbers that are not readily vulcanized by phenolic curable resins, it is desirable to use halogen donors and zinc oxide together. The method of producing halogenated phenolic curable resins and the use thereof in curative systems using zinc oxide are all described in U.S. Pat. Nos. 2,972,600 and 3,093,613, the disclosures of which are incorporated herein by reference together with the disclosures in U.S. Pat. Nos. 3,287,440 and 3,709,840, above. Examples of suitable halogen donors include ferrous chloride, ferric chloride, or halogen-donating polymers such as chlorinated paraffins, chlorinated polyethylene, chlorosulfonated polyethylene and polychlorobutadiene (neoprene rubber). The term “activator” as used herein refers to any substance that substantially increases the crosslinking efficiency of phenolic curable resins and includes metal oxides and halogen donors, which may be used alone or in combination. For more information on phenolic curative systems, see “Vulcanization and Vulcanizing Agents” (W. Hoffman, Palmerton Publishing Company).

The use of halogenated phenolic curable resins as phenolic resins used as crosslinking agents eliminates the need to use, for example, tin chloride catalysts as catalysts, thereby reducing the environmental impact during production. Furthermore, since the resulting thermoplastic elastomer composition does not contain tin derived from tin chloride catalysts, degradation can be prevented when the polyacetal is in contact with the composition.

Phenol resin-based crosslinking agents, such as suitable phenolic curing resins and brominated phenolic curing resins, can be obtained commercially, for example, such phenol resin-based crosslinking agents can be purchased from Schenectady Chemicals, Inc. under the trade names “SP-1045”, “CRJ-352”, “SP-1055”, and “SP-1056”. Similar action-equivalent phenolic curing resins can also be obtained from other suppliers.

The phenol resin-based crosslinking agents of the present disclosure are suitable crosslinking agents from the viewpoint of fogging prevention because they generate less decomposition products.

The amount of the phenol resin-based crosslinking agent according to the present disclosure is usually 0.5 to 10 parts by mass, preferably 0.5 to 7 parts by mass, and even more preferably 1 to 7 parts by mass, based on 100 parts by mass of the total amount of the ethylene copolymer (A) and the crystalline olefinic polymer (B).

On the occasion of crosslinking treatment with phenol resin-based crosslinking agents, crosslinking auxiliary agents, polyfunctional methacrylate monomers, and polyfunctional vinyl monomers can be blended. Preferably, a crosslinking auxiliary agent such as ZnO is blended.

By using such compounds, a uniform and mild crosslinking reaction can be expected.

It is preferable to use such compounds in the thermoplastic elastomer composition at a ratio of 0.1 to 2% by mass, especially 0.3 to 1% by mass, in order to achieve good flowability of the resulting thermoplastic elastomer and to prevent changes in physical properties due to thermal history during processing and molding.

### Plasticizer (D)

A plasticizer (D), one of the components of the thermoplastic elastomer composition of the present disclosure, is not particularly limited, but a plasticizer usually used for rubber can be used as the plasticizer (D).

Specific examples of plasticizers include petroleum softeners such as process oil, lubricating oil, paraffin, liquid paraffin, polyethylene wax, polypropylene wax, petroleum asphalt, and vaseline; coal tar softeners such as coal tar and coal tar pitch; fatty oil softeners such as castor oil, linseed oil, rapeseed oil, soybean oil, and coconut oil; waxes such as tall oil, sub (factice), beeswax, carnauba wax, and lanolin; fatty acids and fatty acid salts such as ricinoleic acid, palmitic acid, stearic acid, barium stearate, calcium stearate, zinc laurate; naphthenic acid, pine oil, rosin or its derivatives, terpene resin, petroleum resin, coumarone indene resin, synthetic polymer materials such as atactic polypropylene; ester softeners such as dioctyl phthalate, dioctyl adipate, dioctyl sebacate; microcrystalline waxes, liquid polybutadiene, modified liquid polybutadiene, liquid polyisoprene, end-modified polyisoprene, hydrogenated end-modified polyisoprene, liquid thiokol, and hydrocarbon-based synthetic lubricant. Among these, petroleum-based softeners, in particular, process oil is preferably used.

In the present disclosure, the kinematic viscosity of the plasticizer (D) at 40° C. is preferably 95 Pa·s or higher, and 100 Pa·s or higher is more preferred. By using a plasticizer with the above kinematic viscosity, a thermoplastic elastomer composition with excellent tensile characteristics can be obtained.

The kinematic viscosity of the plasticizer (D) at 40° C. is determined by measuring the time it takes for a certain amount of liquid to flow through a capillary tube in accordance with ASTM D 445 and multiplying the outflow time by the viscometer constant.

The plasticizer (D) contained in the thermoplastic elastomer composition is not only the so-called plasticizer added to the thermoplastic elastomer composition, but also includes oil extended when an oil extended ethylene copolymer (A) (e.g. oil extended EPDM, EPT) is used as the above ethylene copolymer (A). In other words, the “plasticizer content” in the thermoplastic elastomer composition of the present disclosure is the total amount of the plasticizer added to the thermoplastic elastomer composition and oil extended in the oil extended rubber.

### Thermoplastic Elastomer Composition

The thermoplastic elastomer composition of the present disclosure is a composition containing the ethylene copolymer (A), the crystalline olefin polymer (B), the crosslinking agent (C), and the plasticizer (D), wherein the content of the plasticizer (D) is less than 130 parts by mass, preferably 120 parts by mass or less, more preferably 110 parts by mass or less, based on 100 parts by mass of the copolymer (A).

The lower limit of the content of the plasticizer (D) is not particularly limited, but is usually 10 parts by mass or more, preferably 40 parts by mass or more, based on 100 parts by mass of the copolymer (A).

The thermoplastic elastomer composition of the present disclosure can provide a molded body with good oil permeability resistance (oil impermeability) by containing the crystalline olefin polymer (B), the crosslinking agent (C), and the plasticizer (D) in the above range, in addition to the ethylene copolymer (A).

The present inventors presume a reason why the molded body composed of the thermoplastic elastomer composition of the present disclosure has excellent oil permeability resistance, as follows.

The present inventors presume that, in a molded body including the thermoplastic elastomer composition of the present disclosure, an island phase including the ethylene copolymer (A) and a sea phase including the crystalline olefin polymer (B) constituting the composition are each dispersed in the molded body, and that the plasticizer (D) is dispersed (contained) in the island phase including the ethylene copolymer (A). In the sea phase including the crystalline olefin polymer (B), an amorphous part and a crystalline part composed of the crystalline olefin polymer (B) are presumed to be mixed.

The present inventors presume that, when oil (e.g., engine oil) is dropped onto a molded body composed of the thermoplastic elastomer composition of the present disclosure, the engine oil is absorbed by the ethylene copolymer (A) in the island phase while penetrating the amorphous part in the sea phase. The present inventors presume that engine oil that is not absorbed (cannot be retained) by the ethylene copolymer (A) is transferred to the amorphous part in the sea phase and surfaces on the surface of the molded body.

From the oil penetration process as such, the present inventors consider that the molded body composed of the thermoplastic elastomer composition of the present disclosure has good oil permeability resistance (oil impermeability) because the ethylene copolymer (A) including the thermoplastic elastomer composition of the present disclosure has a weight-average molecular weight (Mw) of 350,000 or more, which means that it has a large oil holding capacity (high retention).

On the other hand, in thermoplastic elastomer compositions containing 130 parts by mass or more of the plasticizer (D), the oil permeability resistance (oil impermeability) of the molded body may not be improved.

The thermoplastic elastomer composition of the present disclosure preferably contains the crystalline olefin polymer (B) in the range of 20 to 100 parts by mass, more preferably 40 to 60 parts by mass, based on 100 parts by mass of the ethylene copolymer (A). When the content of the crystalline olefin polymer (B) is within this range, oil permeability resistance may be more favorable.

The thermoplastic elastomer composition of the present disclosure can be blended with components other than the above ethylene copolymer (A), the above crystalline olefin polymer (B), the crosslinking agent (C), and the plasticizer (D), such as heat stabilizers, antistatic agents, weather stabilizers, anti-aging agents, reinforcing agents, fillers, coloring agents, and lubricants, as needed, to the extent not impairing the object of the present disclosure.

### Method for Producing Thermoplastic Elastomer Composition

The thermoplastic elastomer composition of the present disclosure is dynamically crosslinked, whereby at least a portion of the ethylene copolymer (A) and the crystalline olefin polymer (B) in the thermoplastic elastomer composition are crosslinked. When the dynamic crosslinking is performed, dynamic heat treatment is preferably performed in the presence of the crosslinking agent (C) or in the presence of the crosslinking agent (C) and the crosslinking auxiliary agent.

In the present disclosure, the expression “dynamic heat treatment” refers to kneading in a molten state.

Note that the thermoplastic elastomer composition of the present disclosure before dynamic heat treatment is also referred to as a “composition 1”, and the composition which is dynamically heat-treated may also be referred to as a “composition 2”.

The dynamic heat treatment in the present disclosure is preferably performed in a non-open apparatus and in an inert gas atmosphere such as nitrogen or carbon dioxide. The temperature of the heat treatment ranges from the melting point of the component (A) to 300° C. or lower, and is usually 150 to 270° C., and preferably 170 to 250° C. The kneading time is usually 1 to 20 minutes, and preferably 1 to 10 minutes. The shear force to be applied, in terms of the shear velocity, is usually in the range of 10 to 50, 000 s⁻¹, and preferably of 100 to 10,000 s⁻¹.

The timing of addition of the plasticizer (D) in the present disclosure is not particularly limited, but is preferably after completion of the dynamic crosslinking. By adding the plasticizer (D) after the completion of dynamic crosslinking, the plasticizer is less likely to remain in the ethylene copolymer (A), to thereby give a thermoplastic elastomer composition with excellent oil impermeability.

### Applications of Thermoplastic Elastomer Composition

The molded body of the present disclosure is composed of the thermoplastic elastomer composition of the present disclosure.

The thermoplastic elastomer composition of the present disclosure can be molded by various known molding methods. Examples of the molding methods include extrusion, injection molding, compression molding, calendering, vacuum forming, press molding, stamping molding, and blow molding. Examples of the blow molding include press blow molding, direct blow molding, and injection blow molding.

The molded body of the present disclosure has better oil resistance than a molded body composed of a conventional thermoplastic elastomer composition, thereby being suitably used in an application where it is difficult to use a molded body composed of a conventional thermoplastic elastomer composition, for example, an automobile part such as an air intake hose.

### EXAMPLES

Hereinafter, the present disclosure will be described in detail with reference to Examples and Comparative Examples, but the present disclosure is not limited thereto. Unless otherwise specified, “part(s)” used in Examples and Comparative Examples are on a mass basis.

The weight-average molecular weight of the ethylene copolymer (A) was measured by the following method.

### Weight-Average Molecular Weight (Mw)

The weight-average molecular weight was measured by gel permeation chromatography. The measurement conditions are as follows.

### Column: TSKgel GMH6-HT×2+TSKgel GMH6-HTL×2

(each having 7.5 mm I.D.×30 cm, manufactured by Tosoh Corporation)
Column temperature: 140° C.
Mobile phase: o-dichlorobenzene (containing 0.025% BHT)
Detector: Differential refractometer
Flow rate: 1.0 mL/min.
Sample concentration: 0.1% (w/v)
Injection volume: 0.4 mL
Sampling interval: 0.5 sec.
Column calibration: monodisperse polystyrene (manufactured by Tosoh Corporation); #3 std set
Molecular weight conversion: PS conversion/preparation conversion method

The melt flow rate (MFR) of the crystalline olefin polymer (B) was measured by the following method.

### Melt Flow Rate (MFR)

The MFR was measured in accordance with JIS K7210 at a temperature of 230° C. and a load of 2.16 kg.

In Examples and Comparative Examples, the following polymers were used as the ethylene copolymer (A) and the crystalline olefin polymer (B).

### Ethylene Copolymer (A)

(1) EPT-1 (Vistalon 3666): ethylene content=64.0% by mass, ethylidene norbornene content=4.5% by mass, Mooney viscosity [ML (1+4), 125° C.]=52 MU, Mw=460,000, amount of oil extension=75 PHR.
(2) EPT-2 (Keltan 4869C): ethylene content=62% by mass, ethylidene norbornene content=8.7% by mass, Mooney viscosity [ML (1+4), 125° C.]=48 MU, Mw=542,000, amount of oil extension=100 PHR.
(3) EPT-3 (Mitsui EPT 3072 EPM): ethylene content=64% by mass, ethylidene norbornene content=5.4% by mass, Mooney viscosity [ML (1+4), 125° C.]=51 MU, Mw=284,000, amount of oil extension=40 PHR.

### Crystalline Olefin Polymer (B)

(1) PP-1 (E111G): propylene homopolymer commercially available from Prime Polymer Co., Ltd. [melt flow rate (JIS K7210, temperature: 230° C., 2.16 kg load)=0.5 g/10 min (trade name Prime Polypro E111G)].

### Physical Properties of Thermoplastic Elastomer Composition and Molded Body

Evaluation methods for physical properties of thermoplastic elastomer compositions and molded bodies in Examples and Comparative Examples below are as follows.

### Shore A Hardness

Pellets of the thermoplastic elastomer composition obtained were press-formed at 230° C. for 6 minutes and then cold-pressed at room temperature for 5 minutes using a 100 t automatic electrothermal press (manufactured by Shoji Co., Ltd.), to give a press sheet having a thickness of 3 mm. Using the sheet, Shore A hardness was measured in accordance with JIS K6253 by use of a type A meter by reading the scale on the type A meter immediately after contact of the pushing needle.

### Tensile Characteristics

Pellets of the thermoplastic elastomer composition obtained were press-formed at 230° C. for 6 minutes and then cold-pressed at room temperature for 5 minutes using a 100 t automatic electrothermal press (manufactured by Shoji Co., Ltd.), to give a press sheet having a thickness of 2 mm.

A No. 3 dumbbell piece was stamped out from the press sheet having a thickness of 2 mm prepared as described above to give a test piece, and measurement was made using the test piece according to the method of JIS K6301.
Measurement temperature: 23° C.
TB: tensile strength at break (MPa)
EB: tensile elongation at break (%)

### Compression Set (CS)

Pellets of the thermoplastic elastomer composition obtained were press-formed at 230° C. for 6 minutes and then cold-pressed at room temperature for 5 minutes using a 100 t automatic electrothermal press (manufactured by Shoji Co., Ltd.), to give press sheets having a thickness of 2 mm.

In accordance with JIS K6250, the press sheets having a thickness of 2 mm prepared as described above were layered to carry out a compression set test in accordance with JIS K6262.

The test conditions were as follows: A layered sheet having a thickness of 12 mm (four 3 mm thick pieces layered) was used and applied to 25% compression. The compression was performed at 70° C. under the condition of 22 hours, and measurement was made 30 minutes after strain removal (compression).

### Oil Permeability Resistance Test

The opening of a cup having an inner diameter of 50 mm and a depth of 50 mm containing 5 g of engine oil 0 w-20 manufactured by Nissan Motor Co., Ltd. was covered and fixed with the press sheet having a thickness of 2 mm prepared as described above. Thereafter, the cup was turned upside down and retained at 130° C. for 72 hours while the engine oil was allowed to be in contact with the press sheet. After retention, the condition of the surface of the press sheet that had not been in contact with the engine oil was evaluated. The evaluation criteria for oil permeability resistance were as follows.
OO: No shine was observed on the surface of the press sheet and no permeation of engine oil was observed.
O: Shine was observed on the surface of the press sheet and no permeation of engine oil was observed.
X: Shine was observed on the surface of the press sheet with the engine oil permeating and dripping.

### Example 1

A mixture of 175 parts of EPT-1, 76 parts of PP-1, 4 parts of carbon black (PE4993 black MB), 0.8 parts of a crosslinking auxiliary agent (ZnO), 7 parts of a crosslinking agent (phenol resin-based crosslinking agent SP-1055), and 50 parts of a plasticizer (PW-100, kinematic viscosity at 40° C. of 103.2 cSt) obtained was dynamically crosslinked in an extruder (product number KTX-46, manufactured by KOBE STEEL, LTD.; cylinder temperature: C1: 50° C., C2: 50° C., C3: 100° C., C4: 120° C., C5: 120° C., C6: 120° C., C7 to C8: 180° C., C9 to C14: 220° C., die temperature: 250° C., screw rotation speed: 400 rpm, extrusion rate: 100 kg/h) to give pellets of a thermoplastic elastomer composition.

Properties of the resulting thermoplastic elastomer composition were measured by the method described above. The results are shown in Table 1.

### Examples 2 to 6 and Comparative Examples 1 to 4

Pellets of the thermoplastic elastomer compositions in Examples 2 to 6 and Comparative Examples 1 to 4 were obtained in the same manner as in Example 1, except that the components and the amounts thereof blended were changed as shown in Table 1.

Properties of the resulting thermoplastic elastomer compositions were measured by the method described above.

The results are shown in Table 1.

TABLE 1

| | | Example | Example | Example | Example | Example | Example |
|---|---|---|---|---|---|---|---|
| | | 1 | 2 | 3 | 4 | 5 | 6 |
| EPT | EPT-1 (V3666) | 175 | 175 | 175 | 175 | 175 | |
| (Oil extended | EPT-2 (4869C) | | | | | | 200 |
| EPDM) | EPT-3 (3072EPM) | | | | | | |
| PP | PP-1 (E111G) | 76 | 76 | 76 | 76 | 47 | 47 |
| Carbon black | PE4993 black MB | 4 | 4 | 4 | 4 | 4 | 4 |
| Crosslinking | ZnO | 0.8 | 0.8 | 0.8 | 0.8 | 0.8 | 0.8 |
| auxiliary | | | | | | | |
| agent | | | | | | | |
| Phenol resin- | SP-1055 | 7 | 9 | 5 | 7 | 5 | 5 |
| based | | | | | | | |
| crosslinking | | | | | | | |
| agent | | | | | | | |
| Plasticizer | PW-100 | 50 | 50 | 50 | 35 | 25 | |
| | Total (parts) | 313 | 315 | 311 | 298 | 257 | 257 |
| Amount of plasticizer based on 100 | | 125 | 125 | 125 | 110 | 100 | 100 |
| parts of EPDM (parts) | | | | | | | |
| Physical | Shore A hardness | 81 | 81 | 82 | 82 | 74 | 74 |
| properties | TB (MPa) | 12.4 | 11.3 | 10.1 | 13.5 | 10.3 | 11.1 |
| | EB (%) | 530 | 430 | 590 | 550 | 510 | 540 |
| | CS (%) | 33 | 31 | 34 | 32 | 26 | 27 |
| | Oil permeability | ◯ | ◯ | ◯ | ◯◯ | ◯◯ | ◯◯ |
| | resistance | | | | | | |

| | | Comparative | Comparative | Comparative | Comparative |
|---|---|---|---|---|---|
| | | Example 1 | Example 2 | Example 3 | Example 4 |
| EPT | EPT-1 (V3666) | | 175 | 175 | 175 |
| (Oil extended | EPT-2 (4869C) | | | | |
| EPDM) | EPT-3 (3072EPM) | 140 | | | |
| PP | PP-1 (E111G) | 76 | 76 | 47 | 70.6 |
| Carbon black | PE4993 black MB | 4 | 4 | 4 | 24.0 |
| Crosslinking | ZnO | 0.8 | 0.8 | 0.8 | 1.5 |
| auxiliary agent | | | | | |
| Phenol resin- | SP-1055 | 7 | 7 | 5 | 2.3 |
| based | | | | | |
| crosslinking | | | | | |
| agent | | | | | |
| Plasticizer | PW-100 | 85 | 65 | 65 | 74.1 |
| | Total (parts) | 313 | 328 | 297 | 347.5 |
| Amount of plasticizer based on 100 | | 125 | 140 | 140 | 149.1 |
| parts of EPDM (parts) | | | | | |
| Physical | Shore A hardness | 81 | 81 | 73 | 61 |
| properties | TB (MPa) | 8 | 10.9 | 9.2 | 5.7 |
| | EB (%) | 424 | 510 | 460 | 390 |
| | CS (%) | 33 | 34 | 28 | 67 |
| | Oil permeability | X | X | X | X |
| | resistance | | | | |

1. A thermoplastic elastomer composition comprising:
an ethylene copolymer (A) having a weight-average molecular weight of 350,000 or more;
a crystalline olefin polymer (B);
a crosslinking agent (C); and
a plasticizer (D);
wherein a content of the plasticizer (D) is less than 130 parts by mass based on 100 parts by mass of the copolymer (A).

2. The thermoplastic elastomer composition according to claim 1, wherein the ethylene copolymer (A) has a weight-average molecular weight of 420,000 or more.

3. The thermoplastic elastomer composition according to claim 1 or 2, wherein the ethylene copolymer (A) is an ethylene/α-olefin/non-conjugated polyene copolymer.

4. The thermoplastic elastomer composition according to any one of claims 1 to 3, wherein the ethylene copolymer (A) is an ethylene/propylene/non-conjugated diene copolymer.

5. The thermoplastic elastomer composition according to any one of claims 1 to 4, wherein a content of the crystalline olefin polymer (B) ranges from 20 to 100 parts by mass based on 100 parts by mass of the ethylene copolymer (A).

6. The thermoplastic elastomer composition according to any one of claims 1 to 5, wherein the crystalline olefin polymer (B) is a crystalline olefin polymer having a melt flow rate ranging from 0.01 to 3.0 g/10 min as measured according to JIS K7210 at a temperature of 230° C. and a load of 2.16 kg.

7. The thermoplastic elastomer composition according to any one of claims 1 to 6, wherein the crosslinking agent (C) is a phenol resin-based crosslinking agent.

8. A molded body comprising the thermoplastic elastomer composition according to any one of claims 1 to 7.

9. The molded body according to claim 8, which is an automobile part.

10. The molded body according to claim 9, wherein the automobile part is an air intake hose.
